(19) United States
(12) Patent Application Publication
(10) Pub. No.: US 2005/0027569 A1
(43) Pub. Date: Feb. 3, 2005

(54) Systems and methods for documentation of encounters and communications regarding same

(76) Inventors: Sohrab Gollogly, Salt Lake City, UT (US); John T. Smith, Salt Lake City, UT (US); Jill Serbousek, Memphis, TN (US)

Correspondence Address: Partrick A Doody;Hunton & Williams, 1900 K Street N W, Washington, DC, 20006-1109, US

(21) Appl. No.: 10/631,588

(22) Filed: Jul. 31, 2003

(51) Int. Cl. G06F 17/60

(52) U.S. Cl. 705/3

(57) ABSTRACT

Systems and methods for documenting an encounter and communicating about same are described. The systems and methods of this invention generally comprise an electronic records system for creating and maintaining information in electronic records; a point-of-encounter system in communication with the electronic records system, wherein the point-of-encounter system allows a scribe to document the encounter into a predetermined electronic record; and a library of event-specific templates usable for documenting the encounter. The systems of this invention allow new dynamically-generated templates to be created and added to the library of event-specific templates as needed. These systems may comprise various other components, such as, a website comprising information about a specific event; an access system that is capable of allowing a user to view, create and store details in their own electronic record in the electronic records system; a communications system for providing information to recipients; a library of documents for communicating information to the recipients; a compliance system for identifying whether or not each electronic record is complete; and/or a purchasing system capable of allowing goods and supplies to be purchased via a website.

### FIELD OF THE INVENTION

The present invention relates generally to systems and methods of documentation and communication. More specifically, the present invention relates to electronic patient healthcare systems and methods that allow for better and more complete documentation of clinical encounters than currently possible, and that allow for communications regarding same.

### BACKGROUND OF THE INVENTION

With the passing of the Health Insurance Portability and Accountability Act of 1996 (HIPPA), there will soon be a requirement that both the patient and the physician have secure, encrypted access to the patient's medical records electronically. Despite this, and despite the explosive expansion of healthcare management and information technology, very few physicians have made the transition to electronic medical records (EMRs), and EMR companies have achieved only limited inroads into the outpatient practice of medicine. Most existing EMR systems attempt to accommodate the entire scope of medical practice, rather than fitting into a physician's specific practice model, which can vary dramatically from one sub-specialty of medical practice to the next. Expecting busy physicians to adapt their practice to existing EMR technology requires an unrealistic investment of physician time and money. Furthermore, existing EMR systems do not lend themselves to piecemeal integration as a means of achieving the ultimate goal: a complete, paperless electronic medical record. Therefore, it would be desirable to have systems and methods that allow physicians to more easily and efficiently transition to EMRs than currently possible. It would be further desirable to have EMR systems and methods that accommodate a physician's specific medical practice, instead of requiring the physician to accommodate the technology.

The current practice of medicine is changing, with physicians becoming increasingly focused on treating a very narrow spectrum of diseases or injuries. As physicians continue to narrow the scope of the diseases and diagnoses that they treat, such specialization typically means that such physicians go into significant detail about a very limited number of diseases and diagnoses on a regular basis. As a result, their clinical notes and documentation of their encounters with patients tend to be extremely detailed and highly repetitive. Current methods for documenting clinical encounters in a physician's office are cumbersome and difficult. As such, it would desirable to have a way to make the process of documenting such encounters easier and faster than currently possible.

Furthermore, as it is essential to have complete and thorough records for each patient a physician sees, it would also be desirable to have a way to ensure that each patient's medical history is as fully documented as possible. It would therefore be desirable to streamline the documentation process to allow the clinic office administration to run more efficiently.

In today's world, patients have come to expect that detailed, patient-oriented, high quality, credible health information will be available. However, physicians struggle to provide such information while maintaining current levels of practice overhead and compensation. As a result, many patients turn to the Internet to find such information, often times even before they have visited their doctor for a medical event. As many patients are overwhelmed by the complexity and volume of health information that is available to them online, they have difficulty using this information to make reasonable medical decisions. Therefore, it would be desirable for physicians to have a better way of providing detailed, medical event-specific information to their patients, both prior to the clinical encounter and after.

The potential for using medical event-specific websites to increase medical practice efficiency has not been fully realized by patients and physicians. Furthermore, no known disease-specific, or other medical event-specific, websites are currently being integrated with EMRs in the daily practice of medicine. Therefore, it would be desirable to provide detailed, medical event-specific information to patients, and to have this information integrated with the patients' EMRs.

There are presently no suitable EMR systems and methods available for documenting clinical encounters and allowing for communications thereof. Thus, there is a need for such systems and methods.

### SUMMARY OF THE INVENTION

Accordingly, the above-identified shortcomings of existing systems and methods are overcome by embodiments of the present invention, which relates to systems and methods that utilize a multi-dimensional EMR and point-of-care communication system to help ensure clinical encounters are completely documented, and to provide detailed, medical event-specific information to patients. Embodiments of this invention accommodate a physician's specific medical practice. Embodiments of this invention are capable of allowing physicians to use dynamically-generated templates to document their clinical encounters with patients, thereby resulting in easier and more complete documentation of such encounters than currently exists. Embodiments of this invention allow patients to electronically pre-register themselves with a clinic via the Internet prior to their visit, thereby utilizing the patient to create their own electronic medical record, resulting in a medical record which is likely more complete than it otherwise would be. Embodiments of this invention are also capable of providing detailed, medical event-specific information to patients. Finally, embodiments of this invention are also capable of allowing communications regarding clinical encounters to be created and transmitted.

One embodiment of this invention comprises a system for documenting an encounter and communicating about same. The system comprises: an electronic records system for creating and maintaining information in electronic records; a point-of-encounter system in communication with the electronic records system, wherein the point-of-encounter system is capable of allowing a scribe to document the encounter into a predetermined electronic record; and a library of event-specific templates usable in the point-of-encounter system and the electronic records system for documenting the encounter. Each event-specific template contains information relating to a specific event or encounter. The system is capable of allowing new dynamically-generated templates to be created and added to the library of event-specific templates as needed.

The system may further comprise: a website in communication with the electronic records system, wherein the website comprises information about a specific predetermined event; an access system in communication with the electronic records system, wherein the access system is capable of allowing a user to view, create and store details in their own electronic record in the electronic records system; a communications system in communication with the electronic records system and the point-of-encounter system for providing information to predetermined recipients; a library of documents useable with the communications system for communicating information to the predetermined recipients; a compliance system for identifying whether or not each electronic record is complete; and/or a purchasing system in communication with the electronic records system, wherein the purchasing system is capable of allowing predetermined purchasers to purchase predetermined goods and supplies via a predetermined website.

The access system is capable of allowing the user to pre-register for their encounter via a predetermined website. Information is communicated to the predetermined recipients via a communication network, which comprises a telephone, a pager, an e-mail, a voicemail, ground-based mail, and/or a courier.

Other embodiments of this invention comprise an electronic patient healthcare system for documenting a clinical encounter and communicating about same. The system comprises: an electronic medical records system for creating and maintaining patient information in electronic medical records; a point-of-care system in communication with the electronic medical records system, wherein the point-of-care system is capable of allowing a scribe to document a clinical encounter into a patient's electronic medical record; and a library of practice-specific templates usable in the point-of-care system and the electronic medical records system for documenting the clinical encounter. Each practice-specific template contains information relating to a specific event, encounter or diagnosis. A library of documents comprises a letter of referral, an insurance claim form, a summary of follow-up actions to be taken, post-operative care recommendations, treatment modules and instructions, and/or suggestions for medical goods and supplies.

Other embodiments of this invention comprise an electronic patient healthcare method for documenting a clinical encounter and communicating about same. The method comprises: utilizing a scribe to create an electronic medical record for a patient; utilizing a scribe to document a clinical encounter into a patient's electronic medical record; and utilizing a library of practice-specific templates to aid the scribe in documenting the clinical encounter. The method may further comprise: utilizing new dynamically-generated templates to aid the scribe in documenting the clinical encounter, wherein the new dynamically-generated templates are created and added to the library of practice-specific templates as needed; linking a website to the electronic medical records, wherein the website comprises information about a specific predetermined medical event; utilizing the patient as the scribe to create their own electronic medical record; allowing the patient to pre-register for their clinical encounter via a predetermined website; providing information to predetermined recipients; utilizing a library of documents for communicating information to the predetermined recipients; utilizing a compliance system to identify whether or not each electronic medical record is complete; and/or allowing predetermined purchasers to purchase durable medical goods and supplies via a predetermined website.

The predetermined recipients comprise a patient, a physician, a nurse, a medical professional, an insurance company, and/or any appropriate recipient who is entitled to access health information. The library of documents comprises a letter of referral, an insurance claim form, a summary of follow-up actions to be taken, post-operative care recommendations, treatment modules and instructions, and/or suggestions for medical goods and supplies. The scribe comprises a doctor, a medical assistant, a nurse, a secretary, a personal assistant, a professional assistant, and/or a patient.

Further features, aspects and advantages of the present invention will be more readily apparent to those skilled in the art during the course of the following description, wherein references are made to the accompanying figures which illustrate some preferred forms of the present invention, and wherein like characters of reference designate like parts throughout the drawings.

### DESCRIPTION OF THE DRAWINGS

The systems and methods of the present invention are described herein below with reference to various figures, in which:

FIG. 1 is an overall system diagram showing various components of one general embodiment of this invention;

FIG. 2 is a flowchart showing the general steps that may be performed in embodiments of this invention to create a complete and well-documented electronic medical record and establish a potential treatment pathway for a patient;

FIG. 3 is a flowchart showing the steps a patient may undertake in embodiments of this invention to pre-register and pre-educated themselves prior to their clinical encounter with their physician;

FIGS. 4-9 are examples of an online electronic pre-registration form that a patient may access and fill out, in embodiments of this invention, prior to their clinical encounter with their physician;

FIG. 10 is a flowchart showing the steps that may occur in embodiments of this invention when a patient arrives for a clinical encounter with their physician;

FIG. 11 is an example of a pull-down menu of encounter templates that a physician may utilize in embodiments of this invention to select a template for use in documenting a clinical encounter;

FIG. 12 is an example of an electronic schedule that may be utilized in embodiments of this invention;

FIG. 13 is an example of a library of documents that a physician may utilize in embodiments of this invention;

FIG. 14 is a timeline showing the interaction between a scribe and an embodiment of an electronic patient healthcare system; and

FIG. 15 is a diagram showing how embodiments of this invention update information presented to a patient via a website.

### DETAILED DESCRIPTION OF THE INVENTION

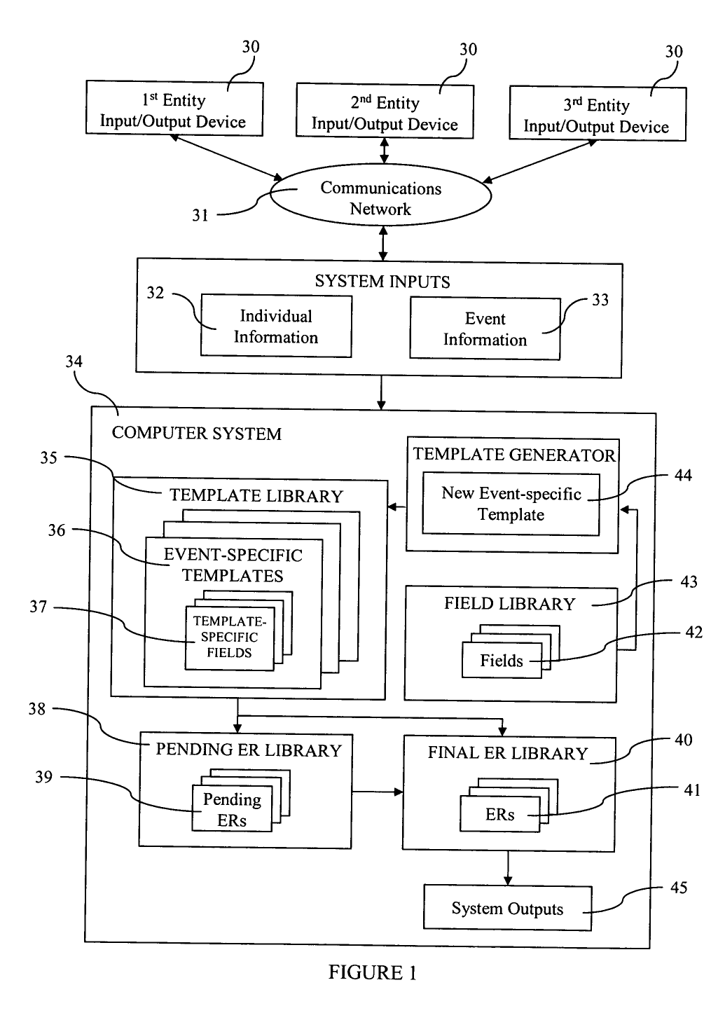

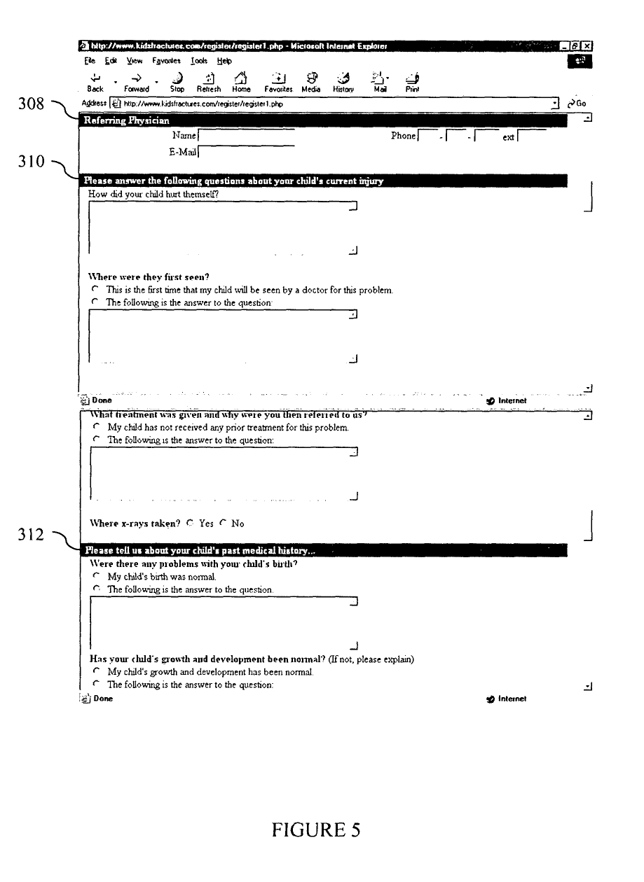

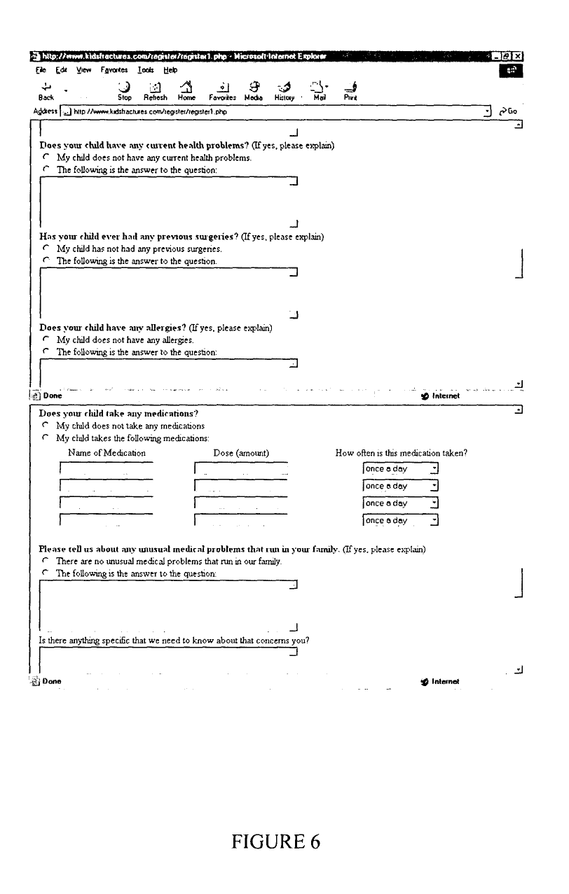

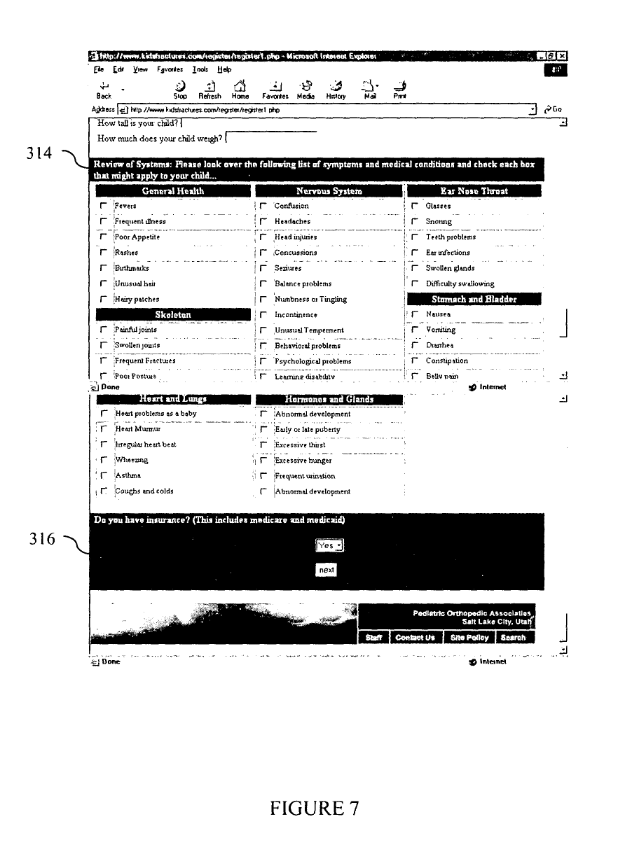

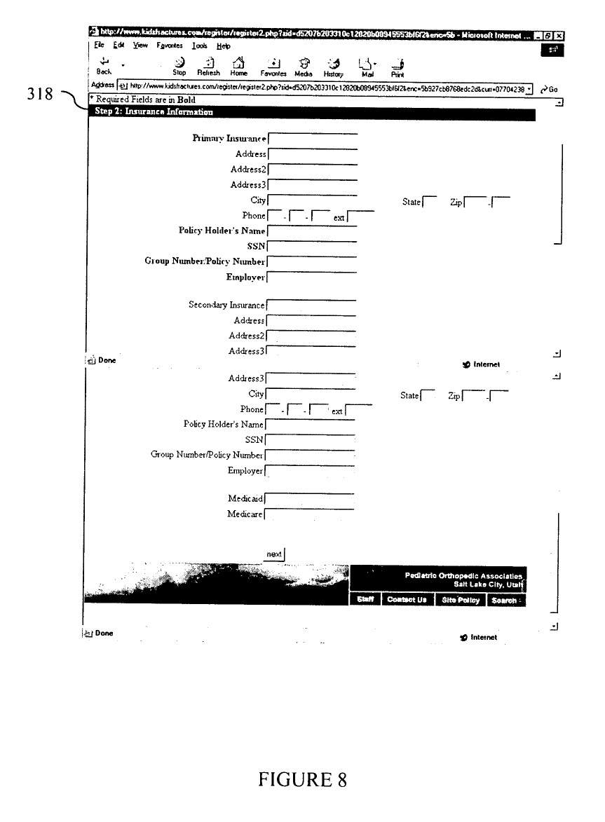

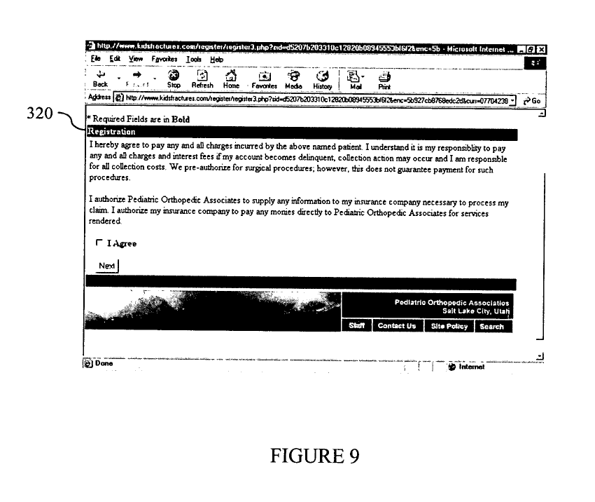

For the purposes of promoting an understanding of the invention, reference will now be made to some preferred embodiments of the present invention as illustrated in FIGS. 1-15, and specific language used to describe the same. The terminology used herein is for the purpose of description, not limitation. Specific structural and functional details disclosed herein are not to be interpreted as limiting, but merely as a basis for the claims as a representative basis for teaching one skilled in the art to variously employ the present invention. Well-known server architectures, web-based interfaces, programming methodologies and structures are utilized in this invention but are not described in detail herein so as not to obscure this invention. Any modifications or variations in the depicted systems and methods, and such further applications of the principles of the invention as illustrated herein, as would normally occur to one skilled in the art, are considered to be within the spirit of this invention.

In a medical environment where more and more patients continue to be seen by a given physician each day, information technology tools can be efficiently used to help ensure that the patients are given the proper information, in a form that is easily accessible to them, prior to the clinical encounter, during the clinical encounter, and even after they return home. Such technology can also be used to ensure that such clinical encounters are completely documented, thereby potentially increasing the level of billing compliance and decreasing the potential for errors in the medical records.

Embodiments of the present invention comprise systems and methods that utilize a multi-dimensional electronic record and communication system to help ensure encounters are completely documented, and to provide detailed, event-specific information to predetermined recipients. In general, these embodiments comprise a communications network 31 that allows numerous users 30 to access the computer system 34 and provide individual information 32 and/or event-specific information 33 thereto. For instance, during an encounter, such as a patient visiting a doctor, the computer system 34 allows a scribe to access a library 35 of event-specific templates 36 that comprise template-specific fields 37 therein. Each template 36, through its predetermined combination of one or more template-specific fields 37, is focused on the specific information needed or desired to document the encounter and the event, such as a medical injury, associated with the encounter. Thus, the scribe can input various information, either selected from predetermined choices or manually entered, into the fields in the template, and then store the partially or fully completed template in a library 38 of pending electronic records (ERs) 39, or in a library 40 of final ERs 41, as appropriate. New templates may be dynamically generated on-the-fly by the scribe by adding to a blank template one or more fields 42 from a field library 43, and/or the scribe may select new fields 42 to add to an existing template from a library 43 of fields 42. In this manner, new event-specific templates 44 can be generated as they become necessary, and these new event-specific templates 44 can then be stored in the library of templates 35 that are available to the scribe. Once a template is fully completed, various types of predetermined documents and/or other communications (i.e., letters, email messages, prescriptions, etc.) can be output 45 from the system 34.

Embodiments of the present invention comprise systems and methods that utilize a multi-dimensional electronic medical record (EMR) and point-of-care communication system to help ensure clinical encounters are completely documented, and to provide detailed, medical event-specific information to patients. Embodiments of this invention may comprise one or more of the following components. First, embodiments may comprise a public domain website that provides medical information to consumers, potential and established patients, and/or other medical professionals via the Internet, and that allows for electronic pre-registration of patients. Second, embodiments may comprise a scribe-based system that is utilized for documenting clinical encounters, surgical and office-based medical procedures, plans of care and/or treatment recommendations. Third, embodiments may comprise an ability to facilitate the creation and transmission of: letters of referral; communication letters; diagnostic information; and the results of laboratory, clinical, and physical examinations, etc. Fourth, embodiments may comprise using several different mechanisms (including hard lines, wireless access devices, hot-sync portals, and other mechanisms) for communicating with the World Wide Web via a remote and/or locally based server to store, retrieve, access and view medical records. Fifth, embodiments may comprise utilizing communication networks, such as telephone, pager, e-mail, voicemail, ground-based mail, courier, etc., to communicate predetermined and/or individual-specific information directly with patients, the general public, and/or other physicians in an event-driven secure manner. Sixth, embodiments may comprise incorporating all types of medical information into the contents of an e-mail and/or a patient-accessible website. Seventh, embodiments may comprise establishing a clinical recovery pathway for a patient and then communicating with the patient via a communications network, such as telephone, pager, e-mail, voicemail, ground-based mail, courier, etc., to remind them of the tasks they need to perform to ensure they follow their recovery pathway properly. Eighth, embodiments may also comprise the ability to facilitate the purchase of durable medical goods that have the potential to improve the patient's participation in their recovery pathway, ease their disability, and/or allow them to function in spite of their medical ailment. While some embodiments may comprise all of these components, other embodiments may comprise less than all of these components, and all such combinations of components are deemed to be within the scope of this invention.

As used herein, “medical event” means any type of medical procedure or medically related event, such as, for example, an operation, a medical procedure, treatment of disease or injury or illness, medical testing, pregnancy, birth of a child, and the like. As used herein, “scribe” means someone who acts as a transcriber of events, conversations, dictations, and/or occurrences. The “scribe” may be any suitable person capable of accomplishing this task, such as for example, a doctor, a medical assistant, a nurse, a secretary, a personal or professional assistant, the patient themselves, or any other suitable person.

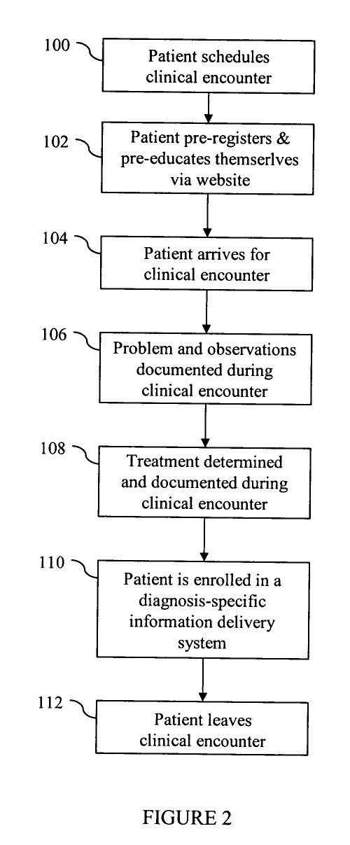

Embodiments of the multi-dimensional EMR and point-of-care communication systems and methods of this invention may comprise the general overall steps shown in FIG. 2. First, a patient may schedule a clinical encounter 100, either on his or her own initiative or via a referral to a specific physician (i.e., specialist) by their primary care physician. Once an appointment is scheduled, the patient may be instructed to visit a website to pre-register electronically 102 before their visit to the physician's office. Pre-registering may comprise completing the registration forms, patient intake forms, and/or medical history forms. In addition to pre-registering, the patient may also be able to access information about their specific medical event so they can arrive on the day of their appointment better informed and pre-educated about their medical event and possible treatment options. The patient may then arrive at the physician's office 104 for the clinical encounter with their registration forms, patient intake forms, and/or medical history forms already completed, and preferably saved to the clinic server as an EMR. During the clinical encounter, the physician may access the patient's saved EMR via a computer interface, and may then document, into the patient's EMR, the problem(s) the patient complains of and any observations the physician makes during the encounter 106. In embodiments, this documentation may comprise using dynamically-generated templates to help ensure the encounter is completely documented. Additionally, while the patient is still in the physician's office, the recommended treatment plan can be determined and documented 108 in the patient's EMR. Furthermore, the patient may be enrolled in a diagnosis-specific communication and information delivery system 10 before they leave the clinical encounter. Thereafter, the patient can leave the clinical encounter 112 knowing that they will be receiving information from their physician (i.e., reminders via e-mail about what tasks they need to accomplish to aid in their recovery/treatment).

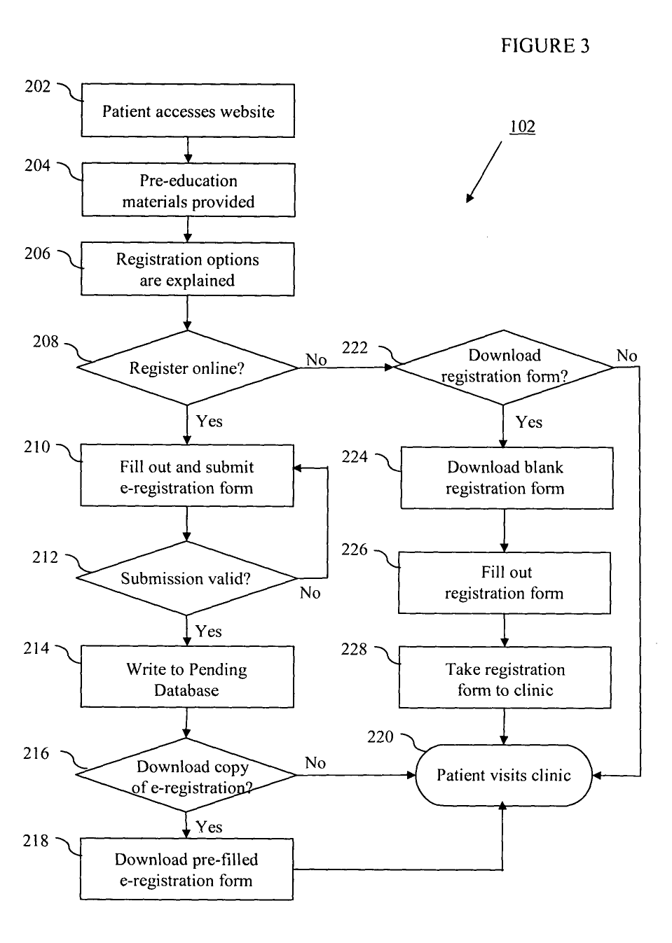

Now, in more detail, the steps that a patient may follow to pre-register and pre-educate themselves prior to their clinical encounter 102, as in embodiments of this invention, are shown in FIG. 3. While making the appointment for a clinical encounter with a physician 100, the patient may be instructed by a physician's office employee to visit a predetermined website. The website the patient is instructed to visit may be specifically designed to address only a few closely-related health issues. For example, a children's fracture clinic may tell its patients to visit a website that is dedicated strictly to information about children's broken bones such as, for example, www.kidsfracture.com. Similarly, other medical clinics may have websites that are designed and dedicated to addressing only their particular areas of medical specialization, such as, for example, back pain, neck pain, scoliosis, or the like.

When the patient visits the predetermined website 202, they may obtain educational information 204 about their medical event and the possible treatment options that may be available to them. This information may be presented in many forms, such as, for example, in the form of answers to frequently asked questions, general information about the specific medical event, and/or links to other helpful related information such as links to: symptoms, causes, treatment options, articles about the medical event, patient stories, anatomy, glossary, and links to help patients find a doctor. Additionally, the patient's registration options may also be explained to them 206. For example, in embodiments of this invention, the patient may be offered three different registration options: (1) pre-register electronically prior to the clinical encounter by registering online; (2) partially pre-register prior to the clinical encounter by downloading a copy of the registration form and manually filling it out at home; and/or (3) registering in the clinic office when the patient arrives for their clinical encounter. Some sort of pre-registration is desirable because it often times allows for more complete information to be documented in the patient's medical record than if the patient merely registers in the clinic office. Pre-registering electronically online also improves the efficiency of the clinic administration by utilizing the patient to create his or her own EMR, thereby streamlining the documentation process.

If a patient decides to pre-register prior to their clinical encounter by electronically registering online 208, they can fill out and submit an e-registration form that is accessible via the website 210. There may be programming involved that allows the system to verify whether or not an e-registration is valid 212. For instance, an e-registration may not be valid if predetermined fields are not completed. Such predetermined fields may include: patient name, patient address, patient social security number, medical complaint, etc. If a patient's e-registration is not valid, the patient may be instructed to correct any errors, and then resubmit their e-registration 211. Once a valid e-registration form is submitted, the e-registration may then be transmitted and saved to a server controlled by the clinic office 214. Such information may be saved to a “Pending” database, which merely means that the information contained in the EMR has not yet been verified and/or confirmed by the patient and/or clinic employee at the time of the office visit. Alternatively, the e-registration may be printed out and hand carried to the clinic, or it can be stored on any type of memory device that can be used to recall the information. Thereafter, the patient may be given the option of downloading and/or printing a copy of their e-registration 216 prior to their visit to the clinic 220.

If a patient decides to partially pre-register prior to their clinical encounter by manually filling out the registration form 222, they may download a copy of the registration form at the website 224, and thereafter manually fill it out 226 and take the completed registration form with them to the clinic office 228. Alternatively, the partial e-registration may be printed out and hand carried to the clinic, or it can be stored on any type of memory device that can be used to recall the information. This method may be completed by someone other than the patient, such as a scribe at the physician's office, who completes entry of all the information into the system and creates an EMR for the patient once the patient arrives at the clinic for his or her appointment 220.

Alternatively, or if a patient does not have access to the website, a patient may decide to register once they arrive in the clinic office by manually filling out the registration form in the clinic office as has customarily been done in the past. This method is completed by someone other than the patient, such as a scribe at the physician's office, who inputs the patient's information into the system and creates an EMR for the patient.

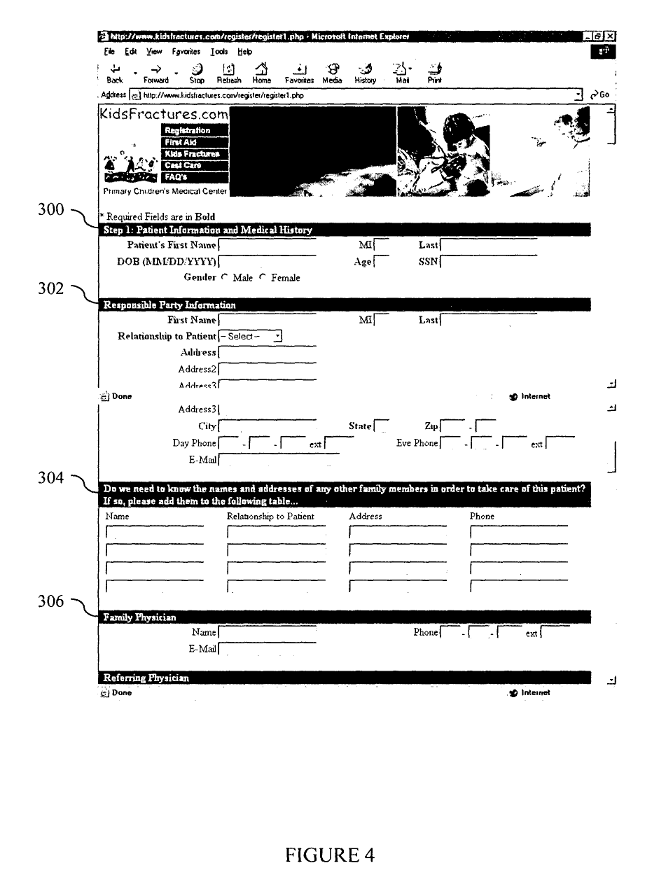

An exemplary electronic registration form is shown in FIGS. 4-9. General patient information 300, such as, for example, the patient's name, date of birth, age, gender and social security number, may be collected on such forms. Other typically requested information may also be requested, such as, for example, contact information for the responsible party 302. Other pertinent information may also be sought, such as, for example, information about other family members 304 that may be relevant to treatment, family physician 306, and the referring physician 308. Thereafter, information specific to the medical event can be sought 310. In this particular embodiment, which relates to a children's fracture clinic, such questions involve topics like: how the child was hurt, where they were first seen by a physician, what treatment was given, and whether or not x-rays were taken. Information about the child's past medical history can also be sought 312. Next, a review of systems can be completed 314, and the patient can disclose whether or not they have insurance coverage 316. Thereafter, the patient's insurance information can be collected 318, and the online e-registration can be submitted 320.

Such e-registration forms, as well as paper registration forms that are available in the clinic office, can be custom designed so as to ask for information relevant to a given medical specialty or sub-specialty. For example, while the registration form depicted here asks for information specifically related to children's fractured bones, the registration form could just as easily be designed to ask questions related to back problems or any other medical illness or injury, and all such modifications are intended to be within the scope of this invention.

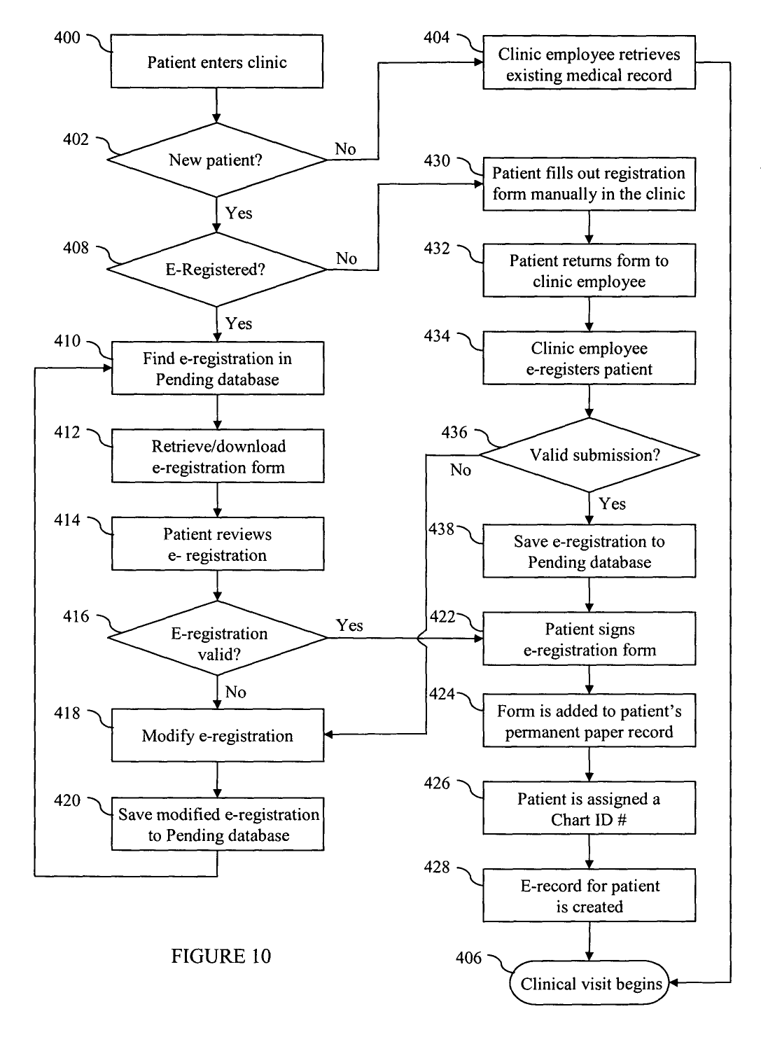

Now, the general steps that may occur when a patient arrives for a clinical encounter with their physician are shown in FIG. 10. In this embodiment, when the patient enters the clinic 400, it may first be determined whether or not they are a new patient 402. If they are not a new patient, the clinic employee may simply retrieve the patient's EMR 404, and the patient can wait to be seen by the physician 406. If they are a new patient, it may next be determined whether or not they pre-registered electronically via the clinic's website prior to their visit 408.

If they did pre-register electronically via the clinic's website, their e-registration may be located in the clinic's “Pending” database 410. The e-registration may then be retrieved and downloaded 412 so the patient can review the information therein and ensure that it is correct 414. If the patient's e-registration is not valid 416, or if there are errors that need to be corrected, the e-registration can be modified 418, and the modified e-registration can be saved to the “Pending” database 420. Once a valid e-registration exists, the patient can sign the e-registration form 422, the form can be added to the patient's permanent paper medical record 424, the patient can be assigned a chart identification number 426, and a permanent EMR can be created for the patient 428.

If the patient did not pre-register electronically via the clinic's website, the patient may be given a paper registration form to fill out 430. Once completed, this form can then be returned to a clinic employee 432, and a clinic employee can enter the patient's information into the electronic records system 434, thereby e-registering the patient. Once a valid e-registration exists 436, the patient's e-registration can be saved to the “Pending” database 438. Thereafter, the patient can sign the e-registration form 422, the form can be added to the patient's permanent paper medical record 424, the patient can be assigned a chart identification number 426, and a permanent EMR can be created for the patient 428.

Embodiments of this invention also comprise a scribe-based system that may be utilized for documenting clinical encounters, surgical and office-based medical procedures, and any other medical events, plans of care and/or treatment recommendations. Some or all information, such as observations or details of a physical examination relating to the patient, a diagnosis of the problem(s) of which the patient complains, observations the physician makes during the encounter, and any recommendations for treatment and/or follow-up, etc., may be recorded in the patient's medical record. Embodiments of this invention can be utilized to have a scribe document the details of the clinical encounter, the treatment and procedure details, and/or the recommendations and plan for follow-up directly into the patient's EMR via a computer in the examination room. Numerous mechanisms are available for communicating with a server via the World Wide Web, and all such mechanisms are deemed to be within the scope of this invention. For example, the scribe may communicate with the clinic's remote and/or locally-based server using a hard line, a wireless access device, and/or a hot-sync portal to store, retrieve, access and view the patient's EMR.

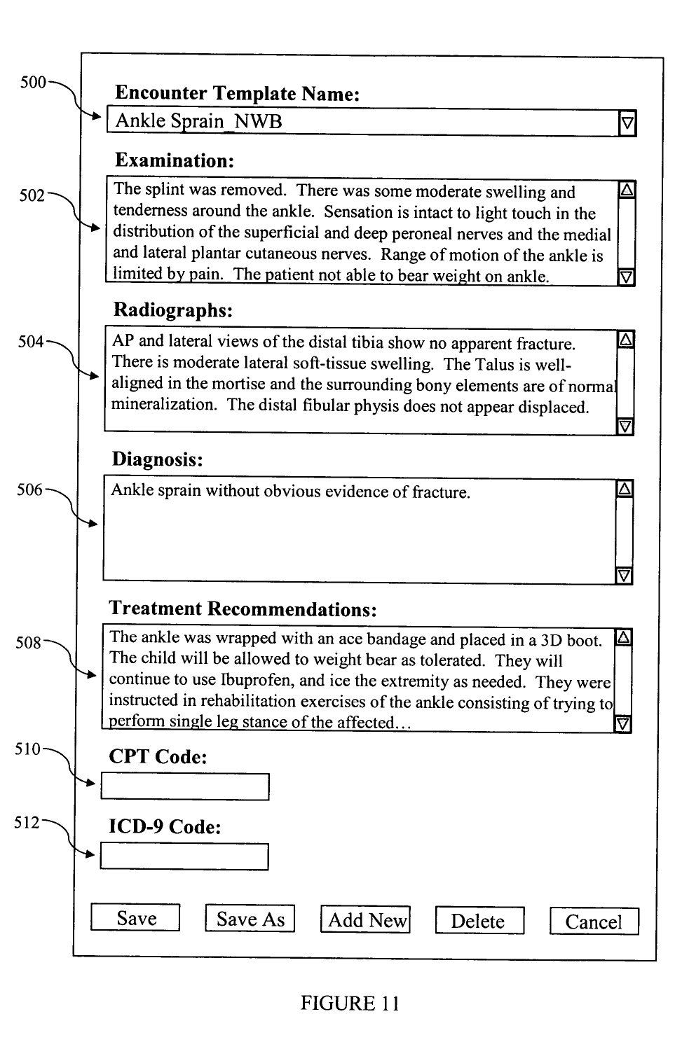

Templates may be used to help ensure that each clinical encounter is efficiently and completely documented in the patient's EMR. An initial library of such templates may be created to provide form documents for each physician's most commonly seen medical events, diagnoses, treatments, follow-up recommendations, outcome assessment tools, prescriptions, consent forms, referral letters and other forms, etc. These templates may contain fields therein that can be filled in by the scribe during the clinical encounter. The templates that are available may be presented to the scribe in any suitable manner, such as for example, via a pull-down list of available templates 500 such as that shown in FIG. 11. The list of available templates may vary depending upon the medical sub-specialty the physician practices in. For example, for the children's fracture clinic that was previously discussed, the list of available encounter templates may comprise: medical events, diagnoses, treatments, follow-up recommendations, new patient visit, follow-up patient visit, new fracture reduction, follow-up fracture reduction, telephone call, request for further information, and any diagnosis specific encounter, such as a new ankle sprain, follow-up ankle sprain, Ankle Sprain_NWB, etc.

Once a template is selected, the scribe can then proceed to fill in the fields in the template. In this particular template, called “Ankle Sprain_NWB”, there are fields for the scribe to enter information regarding the examination 502, the radiographs 504, the diagnosis 506, the treatment recommendations 508, the CPT Code 510, and the ICD-9 Code 512. The layout and contents of the template may vary depending upon which encounter template 500 is selected. Various templates can be created to suit various applications, and all such variations are deemed to be within the scope of this invention.

Consistently filling in all or some predetermined fields in a template for a given medical event provides a consistent and repetitive level of documentation for each event or encounter. Additionally, such detail in the documentation of clinical encounters may help improve billing compliance and billing efficiency, and may lead to higher billings per visit for doing the work that is generally always done anyways, but that may not otherwise be billed.

The fields in these templates may be completed in any suitable manner, such as for example, by using keyed data entry, touch pad data entry, voice recognition data entry, optical character recognition, detailed blocks of text or phrases that are inserted with a predetermined command, or any other suitable manner. In embodiments, physicians or other suitable persons may be able to record dictations as an electronic audio file, such as a .wav, .mpeg, .mp3, .wma file, etc., and then attach the audio file to the patient's EMR so as to preserve the original dictation therein for future reference. Additionally, in embodiments of this invention, digital radiographs, digital thumbnails of x-rays, clinical pictures, images from the diagnostic devices such as arthroscopes, and the like, may be attached or otherwise incorporated into the patient's EMR. Such information is often times an invaluable part of the physician's clinical notes.

As many specialists often see the same types of medical events over and over, specific templates may initially be created to address those commonly recurring medical events. Additionally, as these specialists run into new medical events and/or new diagnoses, new templates can be readily created and saved, thereby increasing the library of templates available to the physician. Such templates may be dynamically-generated as they are needed, by saving the current document as a template for subsequent use, thereby enlarging the library of templates that is available to a specific physician. For instance, the scribe may initially utilize a blank form for documentation. This form may be modified by adding new fields for data entry, and may also be modified by adding data to any or all of the fields within the form. For example, a blank form is used to document the care of a patient with a broken wrist. In the course of this encounter, the form is modified to include a new field for data entry that contains the text describing the interpretation of radiographs. This document is then saved as a part of the patient's medical record, and a copy of the document (without the identifying personal health information) is also saved as a new template. A subsequent patient is seen for a broken leg. The original template is further modified, by adding, deleting, or changing the text of the previous document to reflect the details of the current encounter. The form can be modified to include additional fields for data entry. Again, the document is saved as a part of the patient's medical record and a copy of this form is also saved as an additional template. This process of dynamically generating templates creates a progressively expanding library of customizable event-specific documentation templates.

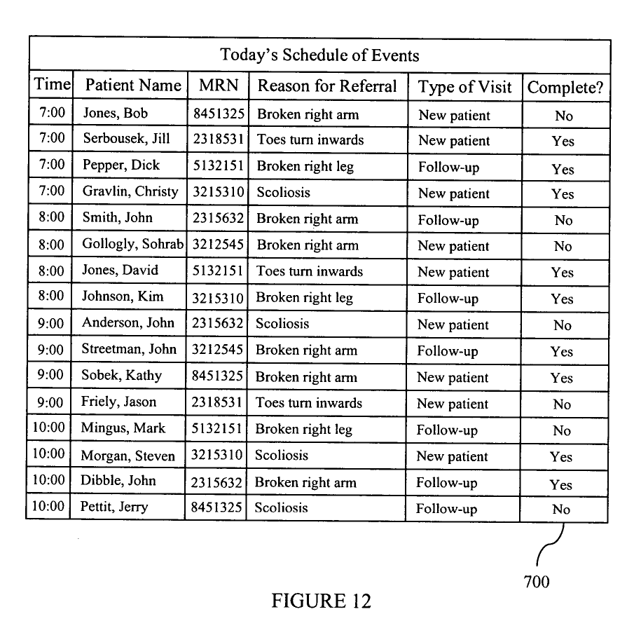

As incomplete documentation is a big problem for a lot of physician's offices, embodiments of this invention may also comprise a compliance system that identifies whether or not a patient's EMR has been completed in a manner that meets a predetermined standard. The predetermined standard may include one or more of the following requirements: all fields are completed, critical fields are completed, and/or the document has been confirmed as completed, such as by the scribe or a subsequent reviewer. Such compliance may be indicated in any suitable manner, such as for example, via a daily schedule as shown in FIG. 12. A “No” in the complete column 700 may indicate that the documentation in the patient's EMR is not complete, prompting further review, while a “Yes” in this column 700 may indicate that the documentation in the patient's EMR is complete.

While still in the clinic office, the patient may be enrolled in a event-driven proactive communication and information delivery system (FIG. 2, block 110). Once enrolled, the physician may then communicate with the patient about the clinical encounter. For example, the physician may send the patient an e-mail message or other type of communication after a predetermined period of time to remind the patient of an action they must take to help enhance their recovery (i.e., get x-rays, go to physical therapy, check out new information contained in the e-mail or on a predetermined website, etc.).

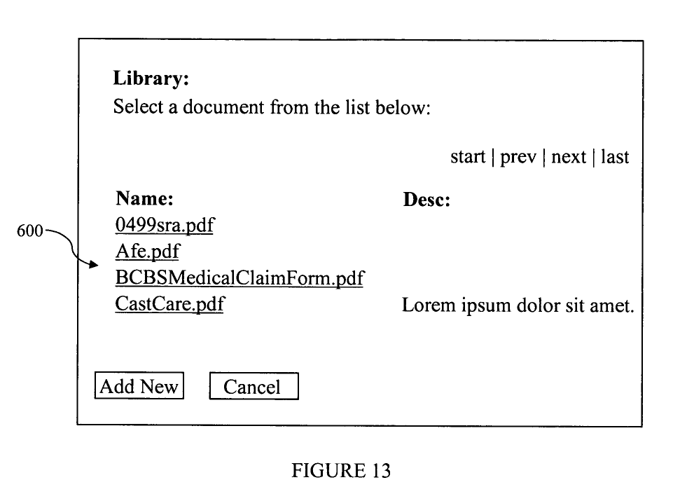

The physician may also have a library of documents created for them so they can more easily provide detailed, event-specific information to their patients, the general public, other physicians, and/or insurance companies, or the like. An example of such a library of documents 600 is shown in FIG. 13. Such documents may comprise: a standardized insurance claim form, a summary of follow-up actions the patient should take, post-operative care recommendations, treatment modules and instructions, suggestions for necessary or desirable medical goods and/or supplies, outcome assessment tools, forms, educational material, prescriptions, referral letters, and the like. The physician may use these documents to easily communicate with a desired recipient, without requiring the physician to recreate such repetitive information every time the need arises. For example, in embodiments of this invention, the physician may have the ability to communicate directly with their patients, the general public, other physicians and/or insurance companies or the like via e-mail in an event-driven manner, utilizing available and sufficient technology for providing security. All types of medically-related information may be communicated in any suitable manner. For example, the information may be incorporated directly into the body of an e-mail, the information may be attached to an e-mail, or an e-mail may simply instruct the recipient to access a specific website to obtain the information. Embodiments of this invention may also comprise an ability to facilitate the creation and transmission of: letters of referral; communication letters; diagnostic information; the results of laboratory, clinical, and physical examinations; insurance claims forms; prescriptions; instructions; educational material; outcome assessment tools; etc.

In embodiments of this invention, the systems may have the ability to create, store, modify and/or display EMRs that can be created by the patient or another participant in the patient's care. The EMRs may be stored on any suitable computer, such as the computer that is used by the scribe, and/or it may be stored on a local or remote server in a database, such as a structured query language (SQL) database. Additionally, the data may be accessed via any web browser (i.e., Netscape Navigator, Internet Explorer, etc.) that has a connection to the server either directly or via the World Wide Web, including all means of telephone, Ethernet, a virtual private network (VPN), infra-red, and/or wireless connectivity, or the like. This will allow both the patient and the physician to have easy access to a patient's medical records anytime and anywhere.

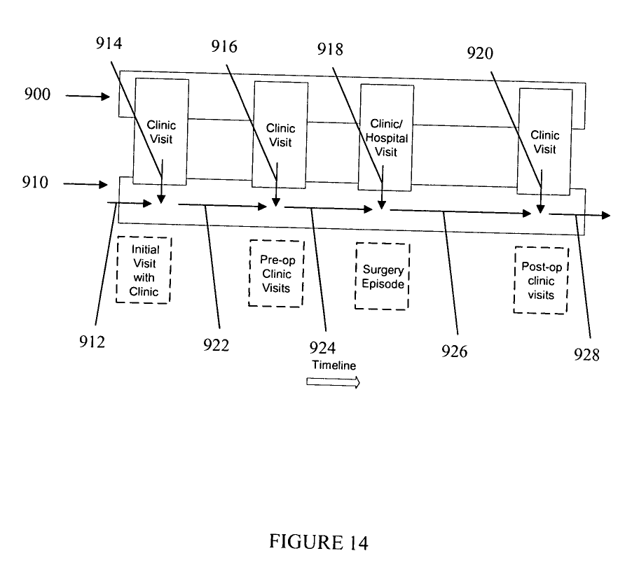

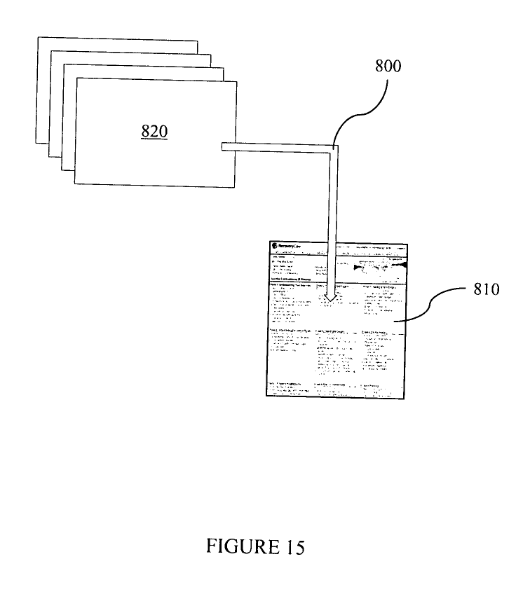

Embodiments of this invention may comprise establishing a clinical treatment recovery pathway for a patient, and then communicating with the patient via a communications network, such as telephone, pager, e-mail, voicemail, ground-based mail, courier, etc., to remind them of the tasks they need to perform to ensure they follow their recovery pathway properly. As used herein, “recovery pathway” means any accepted sequence of events from injury or medical event to consultation, diagnosis, formulation of a treatment plan, treatment, follow-up, and measurement of clinical outcomes. An exemplary recovery treatment pathway 910, showing the interaction between the event-based recording and communication system 900 and the pathway system 910, for instance as generated by a website, is shown in FIG. 14. For example, for a patient with a medical problem, an initial patient/injury-specific recommended treatment pathway 912 may be generated by system 910 based on predetermined inputs, such as the health condition of the patient and the specific details of the medical problem. Additional information 914, 916, 918, 920 related to the patient or medical problem may be gathered by the recording and information system 900, such as during clinic or hospital visits, and be communicated to the pathway system 910. This additional information 914, 916, 918, 920 may or may not thereby cause the pathway system 910 to generate a modified treatment pathway 922, 924, 926, 928 depending on how the additional information affects the previously recommended treatment pathway. In other words, the information that is specific to the documentation generated by the recording and communication system can be integrated into a strategy for delivering information and instructions to any recipient. For example, a separate website 810 may provide information to a patient in an event and time dependent fashion, as depicted in FIG. 15. This information comprises educational material, instructions, task lists, etc. The information 820 that is delivered 800 to the website can be modified or altered, and the information that the patient is scheduled to receive will be updated in this manner on the website 810. For example, a patient may be enrolled in a treatment pathway (such as one provided by www.recoverycare.com) that delivers information specific to a medical treatment, such as that for back pain. If, in the course of a medical encounter, a recommendation for surgical treatment is made, this information can be stored in the patient's EMR. The information 820 delivered by www.recoverycare.com 810 to the patient can then be altered to reflect this change in diagnosis and prescribed treatment.

Embodiments of this invention may also comprise the ability to facilitate the purchase of durable medical goods that have the potential to improve the patient's participation in their recovery pathway, ease their disability, and/or allow them to function in spite of their medical ailment. This may comprise providing a link on a predetermined public domain website where patients can purchase such medical goods online, either directly from the clinic or from another source.

As described above, embodiments of this invention may integrate disease-specific, or other medical event-specific, websites with EMRs in the daily practice of medicine. Additionally, embodiments of this invention may comprise allowing scribes to utilize dynamically-generated templates to more easily and more completely document clinical encounters in patients' EMRs. Embodiments of this invention may also comprise providing detailed, medical event-specific information to patients, and having this information integrated with the patients' EMRs.

Various embodiments of the invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. For example, while this invention has been described in terms of systems and methods that allow for the efficient and complete documentation of children's fractures and communications regarding the same, numerous other types of medical events, and/or any other type of event, could be documented and communicated about by suitably modifying the systems and methods of this invention. Thus, it is intended that the present invention cover all suitable modifications and variations as come within the scope of the appended claims and their equivalents.

1. A system for documenting an encounter and communicating about same, the system comprising:
an electronic records system for creating and maintaining information in electronic records;
a point-of-encounter system in communication with the electronic records system, wherein the point-of-encounter system is capable of allowing a scribe to document the encounter into a predetermined electronic record; and
a library of event-specific templates usable in the point-of-encounter system and the electronic records system for documenting the encounter.

2. The system of claim 1, wherein each event-specific template contains information relating to a specific event or encounter.

3. The system of claim 1, wherein the system is capable of allowing new dynamically-generated templates to be created and added to the library of event-specific templates as needed.

4. The system of claim 1, further comprising:
a website in communication with the electronic records system, wherein the website comprises information about a specific predetermined event.

5. The system of claim 1, further comprising:
an access system in communication with the electronic records system, wherein the access system is capable of allowing a user to view, create and store details in their own electronic record in the electronic records system.

6. The system of claim 5, wherein the access system is capable of allowing the user to pre-register for their encounter via a predetermined website.

7. The system of claim 1, further comprising:
a communications system in communication with the electronic records system and the point-of-encounter system for providing information to predetermined recipients.

8. The system of claim 7, further comprising:
a library of documents useable with the communications system for communicating information to the predetermined recipients.

9. The system of claim 8, wherein the information is communicated to the predetermined recipients via a communication network.

10. The system of claim 9, wherein the communication network comprises at least one of the following: telephone, pager, e-mail, voicemail, ground-based mail, and courier.

11. The system of claim 1, wherein the electronic records system comprises a compliance system for identifying whether or not each electronic record is complete.

12. The system of claim 1, further comprising:
a purchasing system in communication with the electronic records system, wherein the purchasing system is capable of allowing predetermined purchasers to purchase predetermined goods and supplies via a predetermined website.

13. An electronic patient healthcare system for documenting a clinical encounter and communicating about same, the system comprising:
an electronic medical records system for creating and maintaining patient information in electronic medical records;
a point-of-care system in communication with the electronic medical records system, wherein the point-of-care system is capable of allowing a scribe to document a clinical encounter into a patient's electronic medical record; and
a library of practice-specific templates usable in the point-of-care system and the electronic medical records system for documenting the clinical encounter.

14. The system of claim 13, wherein each practice-specific template contains information relating to a specific event, encounter or diagnosis.

15. The system of claim 13, wherein the system is capable of allowing new dynamically-generated templates to be created and added to the library of practice-specific templates as needed.

16. The system of claim 13, further comprising:
a website in communication with the electronic medical records system, wherein the website comprises information about a specific predetermined medical event.

17. The system of claim 13, further comprising:
a patient access system in communication with the electronic medical records system, wherein the patient access system is capable of allowing the patient to view, create and store details of their own electronic medical record in the electronic medical records system.

18. The system of claim 17, wherein the patient access system is capable of allowing the patient to pre-register for their clinical encounter via a predetermined website.

19. The system of claim 13, further comprising:
a communications system in communication with the electronic medical records system and the point-of-care system for providing information to predetermined recipients.

20. The system of claim 19, further comprising:
a library of documents useable with the communications system for communicating information to the predetermined recipients.

21. The system of claim 20, wherein the information is communicated to the predetermined recipients via a communication network.

22. The system of claim 21, wherein the communication network comprises at least one of the following: telephone, pager, e-mail, voicemail, ground-based mail, and courier.

23. The system of claim 20, wherein the library of documents comprises at least one of the following documents: a letter of referral, an insurance claim form, a summary of follow-up actions to be taken, post-operative care recommendations, treatment modules and instructions, and suggestions for medical goods and supplies.

24. The system of claim 13, wherein the scribe comprises at least one of: a doctor, a medical assistant, a nurse, a secretary, a personal assistant, a professional assistant, and a patient.

25. The system of claim 13, wherein the electronic medical records system comprises a compliance system for identifying whether or not each electronic medical record is complete.

26. The system of claim 13, further comprising:
a purchasing system in communication with the electronic medical records system, wherein the purchasing system is capable of allowing predetermined purchasers to purchase durable medical goods and supplies via a predetermined website.

27. An electronic patient healthcare method for documenting a clinical encounter and communicating about same, the method comprising:
utilizing a scribe to create an electronic medical record for a patient;
utilizing a scribe to document a clinical encounter into a patient's electronic medical record; and
utilizing a library of practice-specific templates to aid the scribe in documenting the clinical encounter.

28. The method of claim 27, further comprising:
utilizing new dynamically-generated templates to aid the scribe in documenting the clinical encounter, wherein the new dynamically-generated templates are created and added to the library of practice-specific templates as needed.

29. The method of claim 27, further comprising:
linking a website to the electronic medical records, wherein the website comprises information about a specific predetermined medical event.

30. The method of claim 27, further comprising:
utilizing the patient as the scribe to create their own electronic medical record.

31. The method of claim 30, further comprising:
allowing the patient to pre-register for their clinical encounter via a predetermined website.

32. The method of claim 27, further comprising:
providing information to predetermined recipients.

33. The method of claim 32, further comprising:
utilizing a library of documents for communicating information to the predetermined recipients.

34. The method of claim 33, wherein the predetermined recipients comprise at least one of: a patient, a physician, a nurse, a medical professional, an insurance company, and any appropriate recipient who is entitled to access health information.

35. The method of claim 33, wherein the information is communicated to the predetermined recipients via a communication network.

36. The method of claim 35, wherein the communication network comprises at least one of the following: telephone, pager, e-mail, voicemail, ground-based mail, and courier.

37. The method of claim 33, wherein the library of documents comprises at least one of the following documents: a letter of referral, an insurance claim form, a summary of follow-up actions to be taken, post-operative care recommendations, treatment modules and instructions, and suggestions for medical goods and supplies.

38. The method of claim 27, wherein the scribe comprises at least one of: a doctor, a medical assistant, a nurse, a secretary, a personal assistant, a professional assistant, and a patient.

39. The method of claim 27, further comprising:
utilizing a compliance system to identify whether or not each electronic medical record is complete.

40. The method of claim 27, further comprising:
allowing predetermined purchasers to purchase durable medical goods and supplies via a predetermined website.

41. An electronic patient healthcare system for documenting a clinical encounter and communicating about same, the system comprising:
a means for allowing a patient to obtain medical event-specific information and pre-register for a clinical encounter, via a predetermined website, prior to the clinical encounter;
a means for allowing the patient to save their pre-registration information into an electronic medical record, wherein the patient's electronic medical record is saved on a predetermined computer;
a means for allowing a scribe to document the clinical encounter directly into the patient's saved electronic medical record, wherein at least one practice-specific template is utilized to guide the scribe through the documentation of the clinical encounter; and
a means for communicating information electronically to a predetermined recipient after the clinical encounter.

42. The system of claim 41, wherein the system is capable of allowing new dynamically-generated templates to be created and saved to a library of practice-specific templates as needed.

43. The system of claim 41, wherein the predetermined recipient comprises at least one of: the patient, a physician, a nurse, a medical professional, an insurance company, and any appropriate recipient who is entitled to access health information.

44. The system of claim 41, wherein the information that is communication electronically to the predetermined recipient comprises at least one of the following: a letter of referral, an insurance claim form, a summary of follow-up actions to be taken, post-operative care recommendations, treatment modules and instructions, and suggestions for medical goods and supplies.
